(19) United States
(12) Patent Application Publication
(10) Pub. No.: US 2004/0116220 A1
(43) Pub. Date: Jun. 17, 2004

(54) System and method of controlling V-belt type continuously variable transmission

(75) Inventors: Masahiro Yamamoto, Kanagawa (JP); Yoshihisa Kodama, Yokohama (JP); Hironobu Waki, Kanagawa (JP); Donggyun Park, Kanagawa (JP); Makoto Sawada, Aichi (JP)

Correspondence Address: FOLEY AND LARDNER, SUITE 500, 3000 K STREET NW, WASHINGTON, DC, 20007, US

(73) Assignee: JATCO Ltd

(21) Appl. No.: 10/674,818

(22) Filed: Oct. 1, 2003

(30) Foreign Application Priority Data
Oct. 2, 2002 (JP) 2002-290345

(51) Int. Cl. F16H 59/00

(52) U.S. Cl. 474/18

(57) ABSTRACT

A shift control system for a V-belt type CVT is constructed to input a target torque signal obtained by estimating engine torque in accordance with vehicle operating conditions and a target shift ratio of the CVT, input an actual torque signal obtained by detecting actual engine torque, synthesize the target and actual torque signals to provide an estimated-torque signal, and control the line pressure in accordance with the estimated-torque signal.

### BACKGROUND OF THE INVENTION

The present invention relates to a shift control system for a V-belt type continuously variable transmission (refer hereafter to as “CVT”), and more particularly, to estimation of engine torque used for control of the line pressure in a hydraulic circuit for operating primary and secondary pulleys during shift operation.

The V-belt type CVT carries out variable control of the shift ratio by adjusting the width of grooves of the primary and secondary pulleys. In order to prevent slippage of a V-belt looped over the two pulleys, the hydraulic pressure is supplied to the pulleys to produce a pressing force to hold the V-belt. Then, the hydraulic pressure, i.e. line pressure, is controlled in accordance with an input load or torque out of an engine.

### SUMMARY OF THE INVENTION

According to a typical line-pressure controlling method, when controlling the line pressure through a duty valve, it is detected a range in which a maximum input load out of the engine is transmitted with the V-belt held by the centrifugal pressure generated by high-speed rotation of the pulleys. When the range is detected, a lower limit of the duty ratio is switched from a lower limit of a linear response to a minimum of a numerical value, thus securing the responsivity of line-pressure control and the range of shift-ratio control.

In order to appropriately controlling the line pressure in accordance with input torque out of the engine, actual engine torque should be estimated to determine an estimated-torque value. There are two methods of determining estimated torque. The first method is based on an input value of a target torque signal obtained from engine rotation in accordance with vehicle operating conditions and a target shift ratio of the CVT. The second method is based on an input value of an actual torque signal obtained by measuring actual engine torque.

It is the second method that has been adopted typically. The second method is favorable in that an input value of the actual torque signal provides a correct value corresponding to actual engine torque, but unfavorable in that input of the actual torque signal delays as compared with that of the target torque signal. This results in a problem that a time lag from input of the actual torque signal to line-pressure control and pulley operation, particularly, a response lag of a hydraulic system, cannot be covered sufficiently.

It is, therefore, an object of the present invention to provide a system and method of controlling a V-belt type CVT, which can provide correct estimated torque with a time lag from input of the actual torque signal to line-pressure control and pulley operation, particularly, a response lag of the hydraulic system, covered sufficiently.

The present invention provides generally a system for controlling a V-belt type continuously variable transmission (CVT) for a vehicle, which comprises: a source of a line pressure; primary and secondary pulleys arranged on input and output sides, the pulleys being subjected to primary-pulley and secondary-pulley pressures produced from the line pressure; a V-belt looped over the primary and secondary pulleys, the V-belt engaging in V-grooves of the primary and secondary pulleys, the V-grooves being changed in width through a differential pressure between the primary-pulley and secondary-pulley pressures to achieve a target shift ratio of the CVT; and an electronic control unit (ECU) which controls the line pressure, the ECU being programmed to: input a first torque signal obtained by estimating an engine torque in accordance with vehicle operating conditions and the target shift ratio; input a second torque signal obtained by detecting the engine torque; synthesize the first and second torque signals to provide an estimated-torque signal; and control the line pressure in accordance with the estimated-torque signal.

### BRIEF DESCRIPTION OF THE DRAWINGS

The other objects and features of the present invention will become apparent from the following description with reference to the accompanying drawings, wherein:

FIG. 1 is a block diagram showing an embodiment of a shift control system for a V-belt type CVT according to the present invention;

FIG. 2 is a diagram similar to FIG. 1, showing the shift control system;

FIG. 3 is a flow chart showing operation of the embodiment;

FIG. 4 is a diagram similar to FIG. 2, showing control for calculating estimated torque in accordance with a procedure in FIG. 3; and

FIG. 5 is a time chart showing temporal variations in target torque, actual torque, and estimated torque calculated therefrom.

### DETAILED DESCRIPTION OF THE INVENTION

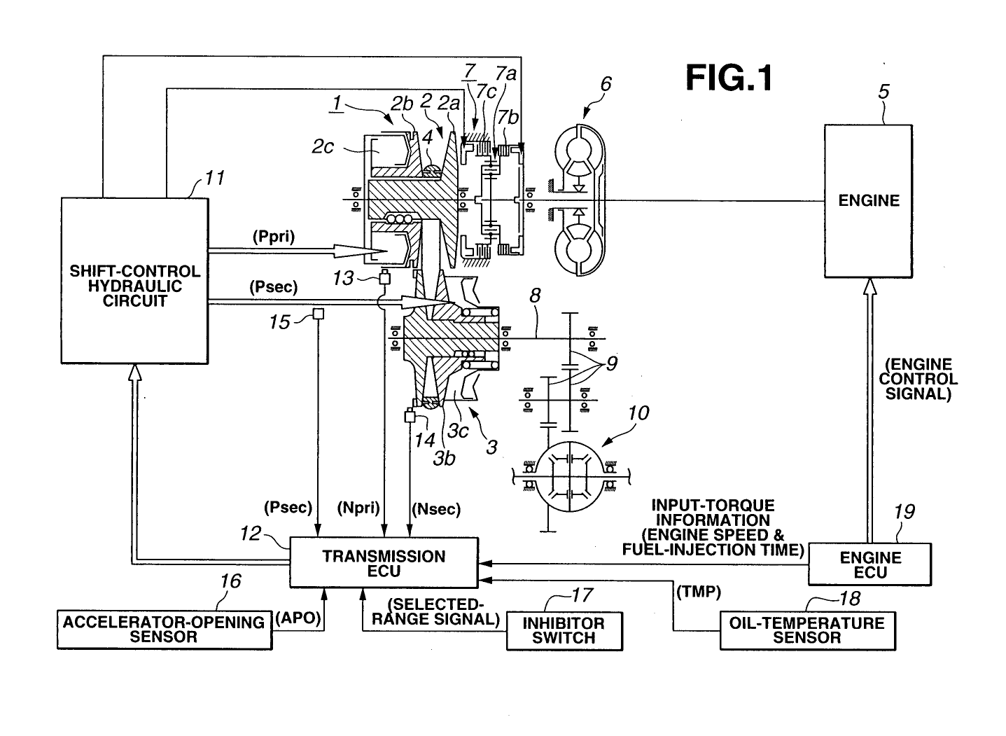

Referring to the drawings, a description is made about a shift control system for a V-belt type CVT embodying the present invention. Referring to FIG. 1, a V-belt type CVT 1 comprises a primary pulley 2, a secondary pulley 3 having a V-groove aligned with that of the primary pulley 2, and a V-belt 4 looped over the primary and secondary pulleys 2, 3 to engage in the V-grooves. An engine 5 is disposed coaxial with the primary pulley 2, and a lockup torque converter 6 and a forward/reverse switching mechanism 7 are arranged between the engine 5 and the primary pulley 2 in this order from the side of the engine 5.

The forward/reverse switching mechanism 7 comprises essentially a double-pinion planetary-gear set 7a including a sun gear coupled to the engine 5 through the torque converter 6 and a carrier coupled to the primary pulley 2. The forward/reverse switching mechanism 7 further comprises a forward clutch 7b for providing direct coupling between the sun gear and the carrier of the planetary-gear set 7a and a reverse brake 7c for fixing a ring gear of the planetary-gear set 7a. When the forward clutch 7b is engaged, the forward/reverse switching mechanism 7 transfers to the primary pulley 2 directly rotation input from the engine 5 through the torque converter 6, whereas when the reverse brake 7c is engaged, the switching mechanism 7 transfers thereto the input rotation as reduced and reversed in direction.

Rotation of the primary pulley 2 is transferred to the secondary pulley 3 through the V-belt 4, which is then transmitted to wheels, not shown, through an output shaft 8, a gear set 9, and a differential gear 10. In order to allow change of the transmission ratio between the primary and secondary pulleys 2, 3 in the process of power transfer, i.e. change of the shift ratio, one of the flanges for defining the V-groove of each of the primary and secondary pulleys 2, 3 includes a stationary flange 2a, 3a, and another includes a movable flange 2b, 3b which can be displaced axially. The movable flanges 2b, 3b are biased toward the stationary flanges 2a, 3b by supplying to a primary-pulley chamber 2c and a secondary-pulley chamber 3c a primary-pulley pressure Ppri and a secondary-pulley pressure Psec produced from the line pressure as source pressure, putting the V-belt 4 in frictional engagement with the pulley flanges, thus allowing power transfer between the primary and secondary pulleys 2, 3. In this embodiment, the pressure acting area of the primary-pulley chamber 2c and that of the secondary-pulley chamber 3c are set equal to each other to avoid one of the pulleys 2, 3 from being larger in diameter than another, achieving downsizing of the CVT 1.

At the time of shifting, the width of the V-belt grooves of the primary and secondary pulleys 2, 3 is changed by a differential pressure between the primary-pulley pressure Ppri and the secondary-pulley pressure Psec produced in accordance with a target shift ratio as will be described later, changing continuously the diameter of circles of the pulleys 2, 3 with respect to the V-belt 4, allowing achievement of the target shift ratio.

A shift-control hydraulic circuit 11 controls output of the primary-pulley pressure Ppri and the secondary-pulley pressure Psec as well as output of the engagement pressure of the forward clutch 7b to be engaged when selecting the forward driving range and the reverse brake 7c to be engaged when selecting the reverse range. The shift-control hydraulic circuit 11 carries out such control in response to a signal of a transmission electronic control unit (ECU) 12. Thus, the transmission ECU 12 receives a signal of a primary-pulley rotational-speed sensor 13 for sensing a primary-pulley rotational speed Npri, a signal of a secondary-pulley rotational-speed sensor 14 for sensing a secondary-pulley rotational speed Nsec, a signal of a primary-pulley pressure sensor 15 for sensing a primary-pulley pressure Ppri, a signal of a secondary-pulley pressure sensor 16 for sensing a secondary-pulley pressure Psec, a signal of an accelerator opening sensor 17 for sensing an accelerator-pedal depression amount APO, a selected-range signal of an inhibitor switch 18, a signal of an oil-temperature sensor 19 for sensing a shift-operation oil temperature TMP, and transmission input-torque related signals, such as engine speed and fuel injection time, of an engine electronic control unit (ECU) 20 for controlling the engine 5.

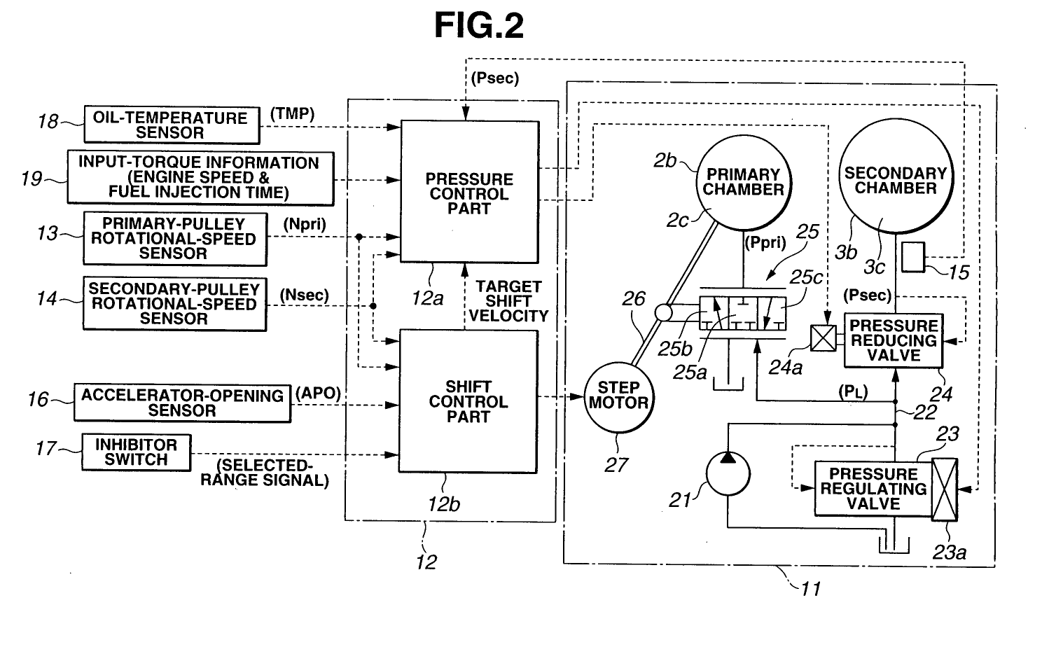

FIG. 2 shows the shift-control hydraulic circuit 11 and the transmission ECU 12. First, the shift-control hydraulic circuit 11 is described. The hydraulic circuit 11 comprises an oil pump 21 driven by the engine 5, a hydraulic passage 22 to which the oil pump 21 supplies hydraulic oil or medium, and a pressure regulating valve 23 for controlling the pressure within the hydraulic passage 22 at a predetermined line pressure P_{L}. The line pressure P_{L} within the hydraulic passage 22 is controlled by a pressure reducing valve 24 and supplied to the secondary-pulley chamber 3c as secondary-pulley pressure Psec on one hand, and it is controlled by a shift control valve 25 and supplied to the primary-pulley chamber 2c as primary-pulley pressure Ppri. The pressure regulating valve 23 controls the line pressure P_{L} in accordance with the drive duty for a solenoid 23a, whereas the pressure reducing valve 24 controls the secondary-pulley chamber Psec in accordance with the drive duty for a solenoid 24a.

The shift control valve 25 has a neutral position 25a, a pressure increasing position 25b, and a pressure reducing position 25c. For switching of the valve positions, the shift control valve 25 is coupled to a shift link 26 roughly in the middle thereof, the shift link 26 having one end coupled to a step motor or shift actuator 27 and another end coupled to the movable flange 2b of the primary pulley 2. The step motor 27 is put in an operated position advanced with respect to a reference position by the step number Step corresponding to the target shift ratio. By such operation of the step motor 27, the shift link 26 swings with a junction with the movable flange 2b as the fulcrum, moving the operated position of the shift control valve 25 from the neutral position 25a to the pressure increasing position 25b or the pressure reducing position 25c. With this, the primary-pulley pressure Ppri is increased by the line pressure PL as source pressure, or decreased by drain to cause change in differential pressure between the primary-pulley pressure Ppri and the secondary-pulley pressure Psec, producing upshift to a high-side shift ratio or downshift to a low-side shift ratio, thus achieving shift toward the target shift ratio.

Development of shift is fed back to a corresponding end of the shift link 26 through the movable flange 2c of the primary pulley 2, so that the shift link 26 swings with a junction with the step motor 27 as the fulcrum in the direction of returning the shift control valve 25 from the pressure increasing position 25b or the pressure reducing position 25c to the neutral position 25a. With this, the shift control valve 25 is returned to the neutral position 25a when achieving the target shift ratio, allowing maintaining of the target shift ratio.

The transmission ECU 12 carries out determination of the solenoid drive duty of the pressure regulating valve 23, the solenoid drive duty of the pressure reducing valve 24, and a shift command or step number Step to the step motor 27 as well as determination as to whether or not the engagement pressure is supplied to the forward clutch 7b and the reverse brake 7c as shown in FIG. 1. As shown in FIG. 2, the transmission ECU 12 comprises a pressure control part 12a and a shift control part 12b. The pressure control part 12a determines the solenoid drive duty of the pressure regulating valve 23 and the solenoid drive duty of the pressure reducing valve 24, whereas the shift control part 12b determines the step number Step of the step motor 27 as follows:

First, using the vehicle velocity which can be obtained from the secondary-pulley rotational speed Nsec and the accelerator-pedal depression amount APO, the shift control part 12b determines a target input rotational speed in accordance with a given shift map. The determined target input rotational speed is divided by the secondary-pulley rotational speed Nsec to determine a target shift ratio in accordance with driving conditions such as vehicle velocity and accelerator-pedal depression amount APO. Then, the primary-pulley rotational speed Npri is divided by the secondary-pulley rotational speed Nsec to obtain an actual or achieved shift ratio, which is corrected in accordance with a deviation with respect to the target shift ratio, determining a shift-ratio command for gradually bringing the actual shift ratio nearer to the target shift ratio at target shift velocity. A step number or operated position Astep of the step motor 27 is determined to achieve the shift-ratio command, which is provided to the step motor 27, thus achieving the target shift ratio through the above shift action.

In this embodiment, as described above, when calculating estimated torque for controlling the line pressure P_{L} of the shift-control hydraulic circuit 11, the shift control system relies on an input value of a target torque signal or first torque signal obtained from engine rotation in accordance with vehicle operating conditions and a target shift ratio of the CVT 1.

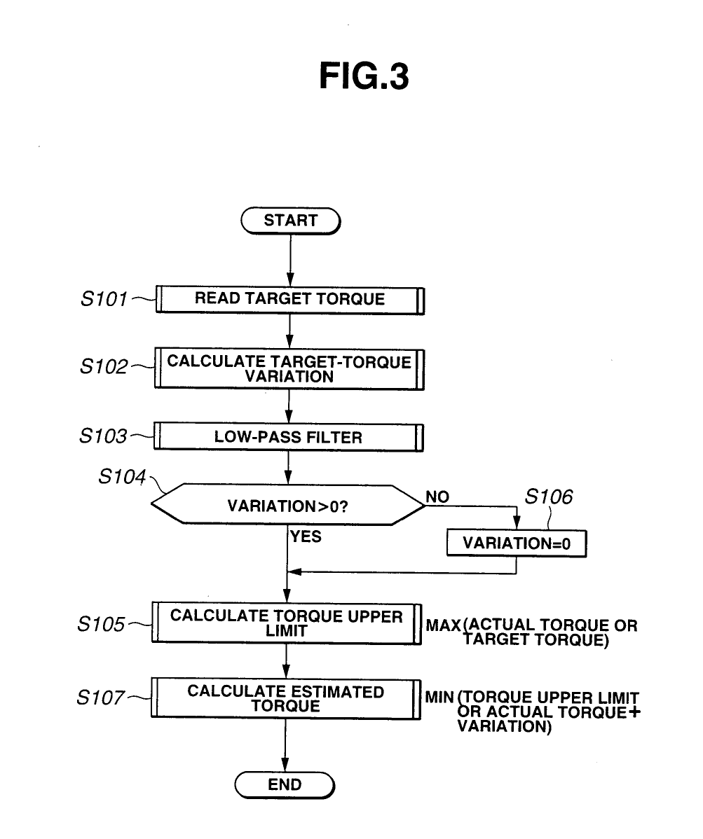

Referring to FIG. 3, the procedure for calculating estimated torque is described. At a step S101, the target torque signal is read in a memory. At a step S102, a variation in target torque signal is calculated. Then, at a step S103, the target torque signal is subjected to differential processing and smoothing processing by a low-pass filter.

At a step S104, it is determined whether or not the variation in target torque signal subjected to filtering processing at the step S103 is positive. If it is determined that the variation>0, flow proceeds to a step S105, whereas if it is determined that the variation≦0, flow proceeds to a step S106 where the variation is set at zero, then proceeds to the step S105.

At the step S105, an upper limit of toque is calculated. Specifically, comparing an actual torque signal or second torque signal read in the memory separately from the target torque signal with the target torque signal, a greater one is set as the upper limit of torque.

At a step S107, an estimated torque is calculated. Specifically, comparing the torque upper limit obtained at the step S105 with a sum of a value of the actual torque signal and the variation in target torque signal, a smaller one is set as the estimated torque.

The reason for carrying out processing at the steps S105 and S107 is to prevent overshoot of an estimated-torque value or rather lack of an increment thereof with respect to time, and thus obtain a stable estimated-torque value.

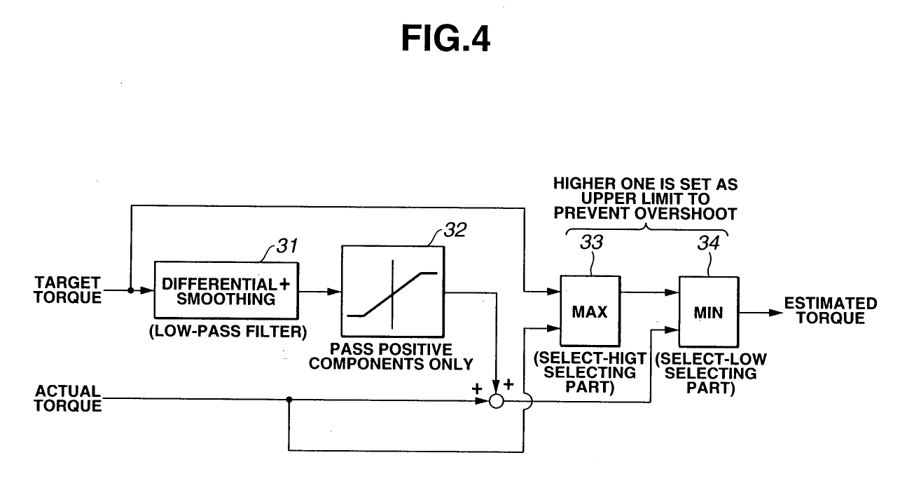

Referring to FIG. 4, control for calculating estimated torque at the steps S105 and S107 in FIG. 3 is described in detail. Input first to this control block are both a target torque signal and an actual torque signal. The target torque signal is branched into two portions. One portion is provided to a low-pass filter 31 to carry out differential processing and smoothing processing. A filtered signal is provided to a filter 32 to pass positive components only, which is then added to the actual torque signal. Another portion is provided to a select-high selecting part 33.

Likewise, the actual torque signal is branched into two portions. One portion is added to the filtered target torque signal as described above. In the same way as another portion of the target torque signal, another portion of the actual torque signal is provided to the select-high selecting part 33, outputting a greater or higher one of the two signals.

An output value of the select-high selecting part 33 and a sum of the filtered target torque signal and the actual torque signal are provided to a select-low selecting part 34, outputting a smaller or lower one of the two values as estimated torque.

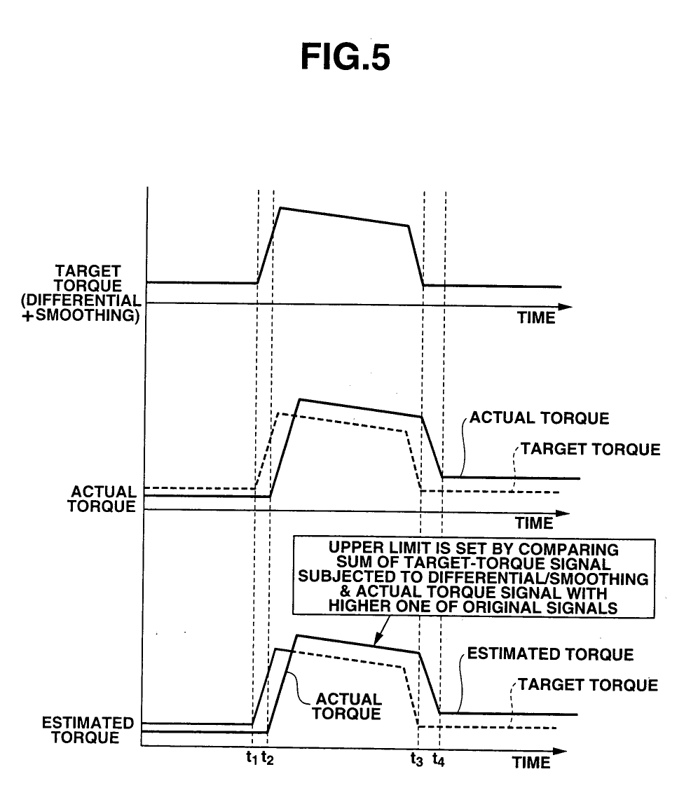

Referring to FIG. 5, the time chart shows temporal variations in target torque after differential processing and smoothing processing, actual torque, and estimated torque obtained in accordance with the above procedure. As shown in FIG. 5, the target torque signal varies in such a way as to rise at point t1, and return to its original value at point t3, whereas the actual torque signal varies in such a way as to rise at point t2 after point t1, and return to its original value at point t4. As described above, an estimated-torque value has an upper limit set by comparing a sum of the target torque signal subjected to differential processing and smoothing processing and the actual torque signal with a higher one of the original signals (target torque signal and actual torque signal), thus having temporal variations without overshoot and the like. Moreover, an estimated-torque value rises at point t1, allowing earlier start of line-pressure control than the method based on input of an actual torque signal.

As described above, in the illustrative embodiment, when determining estimated torque used for line-pressure control, the shift control system inputs a target torque signal obtained from engine rotation in accordance with vehicle operating conditions and a target shift ratio of the CVT, and an actual torque signal. The two input signals are synthesized, based on which estimated torque is calculated. This allows faster determination of estimated torque, providing sufficient covering of a response lag of the shift-control hydraulic circuit, resulting in quick achievement of line-pressure control in accordance with engine torque.

Having described the present invention in connection with the illustrative embodiments, it is noted that the present invention is not limited thereto, and various changes and modifications can be made without departing from the scope of the present invention.

The entire teachings of Japanese Patent Application P2002-290345 filed Oct. 2, 2002 are incorporated hereby by reference.

What is claimed is:

1. A system for controlling a V-belt type continuously variable transmission (CVT) for a vehicle, comprising:
a source of a line pressure;
primary and secondary pulleys arranged on input and output sides, the pulleys being subjected to primary-pulley and secondary-pulley pressures produced from the line pressure;
a V-belt looped over the primary and secondary pulleys, the V-belt engaging in V-grooves of the primary and secondary pulleys, the V-grooves being changed in width through a differential pressure between the primary-pulley and secondary-pulley pressures to achieve a target shift ratio of the CVT; and
an electronic control unit (ECU) which controls the line pressure, the ECU being programmed to:
input a first torque signal obtained by estimating an engine torque in accordance with vehicle operating conditions and the target shift ratio;
input a second torque signal obtained by detecting the engine torque;
synthesize the first and second torque signals to provide an estimated-torque signal; and
control the line pressure in accordance with the estimated-torque signal.

2. The system as claimed in claim 1, wherein the ECU is further programmed to set the first torque signal as the estimated-torque signal when the engine torque rises.

3. The system as claimed in claim 1, wherein the ECU is further programmed to:
subject the first torque signal to differential processing and smoothing processing;
determine a sum of the first torque signal as subjected and the second torque signal; and
determine a greater one of the first and second torque signals;
determine a smaller one of the sum and the greater one; and
set the smaller one as the estimated-torque signal.

4. A vehicle, comprising:
a source of a line pressure;
a V-belt type continuously variable transmission (CVT), comprising:
primary and secondary pulleys arranged on input and output sides, the pulleys being subjected to primary-pulley and secondary-pulley pressures produced from the line pressure; and
a V-belt looped over the primary and secondary pulleys, the V-belt engaging in V-grooves of the primary and secondary pulleys, the V-grooves being changed in width through a differential pressure between the primary-pulley and secondary-pulley pressures to achieve a target shift ratio of the CVT; and
an electronic control unit (ECU) which controls the line pressure, the ECU being programmed to:
input a first torque signal obtained by estimating an engine torque in accordance with vehicle operating conditions and the target shift ratio;
input a second torque signal obtained by detecting the engine torque;
synthesize the first and second torque signals to provide an estimated-torque signal; and
control the line pressure in accordance with the estimated-torque signal.

5. The vehicle as claimed in claim 4, wherein the ECU is further programmed to set the first torque signal as the estimated-torque signal when the engine torque rises.

6. The vehicle as claimed in claim 4, wherein the ECU is further programmed to:
subject the first torque signal to differential processing and smoothing processing;
determine a sum of the first torque signal as subjected and the second torque signal; and
determine a greater one of the first and second torque signals;
determine a smaller one of the sum and the greater one; and
set the smaller one as the estimated-torque signal.

7. A method of controlling a V-belt type continuously variable transmission (CVT) for a vehicle, the CVT comprising:
a source of a line pressure;
primary and secondary pulleys arranged on input and output sides, the pulleys being subjected to primary-pulley and secondary-pulley pressures produced from the line pressure; and
a V-belt looped over the primary and secondary pulleys, the V-belt engaging in V-grooves of the primary and secondary pulleys, the V-grooves being changed in width through a differential pressure between the primary-pulley and secondary-pulley pressures to achieve a target shift ratio of the CVT,
the method comprising:
inputting a first torque signal obtained by estimating an engine torque in accordance with vehicle operating conditions and the target shift ratio;
inputting a second torque signal obtained by detecting the engine torque;
synthesizing the first and second torque signals to provide an estimated-torque signal; and
controlling the line pressure in accordance with the estimated-torque signal.

8. The method as claimed in claim 7, further comprising:
setting the first torque signal as the estimated-torque signal when the engine torque rises.

9. The method as claimed in claim 7, further comprising:
subjecting the first torque signal to differential processing and smoothing processing;
determining a sum of the first torque signal as subjected and the second torque signal; and
determining a greater one of the first and second torque signals;
determining a smaller one of the sum and the greater one; and
setting the smaller one as the estimated-torque signal.
